(19) United States
(12) Patent Application Publication
(10) Pub. No.: US 2010/0332385 A1
(43) Pub. Date: Dec. 30, 2010

(54) ELECTRONIC PAYMENT TRANSACTION SYSTEM

(76) Inventor: Randy Mersky, Silver Spring, MD (US)

Correspondence Address: GREENBLUM & BERNSTEIN, P.L.C., 1950 ROLAND CLARKE PLACE, RESTON, VA, 20191, US

(21) Appl. No.: 12/879,649

(22) Filed: Sep. 10, 2010

Related U.S. Application Data
(63) Continuation-in-part of application No. 11/213,843, filed on Aug. 30, 2005.
(60) Provisional application No. 60/605,134, filed on Aug. 30, 2004.

(51) Int. Cl. G06Q 40/00

(52) U.S. Cl. 705/40

(57) ABSTRACT

Customers are enabled to pay a plurality of creditors via at least one manual payment to an intermediate trustee at a trustee site. A trustee processor disposed at the trustee site operable to process the at least one manual payment and to communicate with at least one of a host processor and a kiosk. The kiosk is disposed proximate to the trustee processor to receive batch payment information, from a customer, pertaining to payments to a plurality of creditors, the kiosk communicating with the host processor, and to process the batch payment information pertaining to the payments to the plurality of creditors. The host processor is disposed at a service provider site remote from the trustee site and adapted to communicate with the kiosk. The host processor receives the batch payment information from the kiosk.

### CROSS REFERENCE TO RELATED APPLICATIONS

This is a Continuation-in-part of pending U.S. patent application Ser. No. 11/213,843, filed on Aug. 30, 2005, which claims priority of U.S. Provisional Application 60/605,134 filed Aug. 30, 2004 entitled “Kiosk for Processing Payment Information”, each of which is incorporated herein by reference in its entirety.

### BACKGROUND OF THE INVENTION

1. Technical Field

The present disclosure pertains to processing payment information. In particular, the present disclosure pertains to a system that conducts transactions (e.g., paying bills, sales of goods and/or services, etc.) over a network and enables users to tender payment manually (e.g., tender payment in the form of cash, check, etc.) for those transactions.

2. Discussion of Related Art

Generally, consumer creditors (e.g., utility companies, banks, credit card companies, department stores, etc.) periodically send statements to notify customers of account balances and requesting payment. The statement includes a summary of account activity and a payment coupon stating the amount due to the creditor or owed to the customer. When an amount is due to the creditor, the consumer typically remits payment to the creditor within a reasonable period of time after receiving the creditor statement. The remittance contains a check (drawn on the consumer's bank) and the payment coupon. The creditor then encodes the amount of the remittance onto the check, deposits the check, and credits the consumer's account in a customer general ledger (“G/L”) account database. Alternately, the remittance is mailed to a lockbox operator who opens the remittance, encodes the check, and captures the consumer's banking information electronically to create an A/R data file. The lockbox operator then sends the A/R data file to the creditor, while sending the encoded check to the bank to be credited to the creditor's bank account. When the consumer's bank receives the check, it withdraws the amount of the check from the consumer's bank account and passes the funds to the creditor's bank account. At some time following the clearing of the check, the creditor also updates its A/R records in the G/L database to credit the consumer's account, and the consumer's bank confirms to the consumer that the withdrawal of the amount of the check by listing it on statement and/or by returning the cancelled check.

Alternatively, customers may arrange to have payments automatically transferred from a customer's bank account to a creditor's account by electronic transfer. This relieves the customer from completing and mailing a check each billing period, and incurs a savings to the customer since the customer does not need to purchase stamps to mail payments.

Furthermore, a user may use an ATM-type system to pay a bill. In such systems, an ATM network access device retrieves bank account information from an ATM card inserted by a consumer to initiate an ATM transaction, and receives appropriate associated PIN information and transaction information from the consumer. The consumer's banking institution verifies the user's account data and verifies that the user has sufficient funds available for the requested transaction. Upon receipt of the authorization message, the ATM banking institution forwards the authorization to the ATM network access device, providing suitable information and funds, if requested, to the user. The consumer then designates the creditor payment and the amount to be paid. Once the consumer has terminated the ATM banking session, the ATM transaction processor forwards a confirmation record of the completed transaction to the ATM banking institution and forwards a record of the transaction and information to facilitate the appropriate debiting and crediting of the necessary accounts to a designated ACH network. The ACH network then operates to debit (where the user has requested a withdrawal of funds, for example) the user's account at the consumer banking institution, and to issue a credit to the ATM banking institution.

There are, moreover, several prior art systems that facilitate customer payment of bills to creditors. For example, U.S. Pat. No. 5,220,501 (Lawlor et al) discloses a system enabling a customer to communicate with a service provider computer from a remote computer site, preferably the customer's home, to facilitate bill paying and/or banking functions. The service provider computer accesses the customer bank computer to selectively perform several banking functions (e.g., account balance inquiries, transfer of funds between accounts, etc.) and pay bills by electronically transferring funds from the customer's account.

U.S. Pat. No. 5,326,959 (Perazzo) discloses a system that enables customer payment of bills to creditors via electronic fund transfers from a customer bank account based on forms submitted by the customer to the customer bank indicating the creditor to receive payment and the payment amount.

U.S. Pat. No. 5,351,994 (Pollin) and U.S. Pat. No. 5,504,677 (Pollin) disclose a system that enables customer payment of bills to creditors by generating a draft payable to the creditor and drawn on the customer's bank account wherein the creditor executes the draft as an authorized signatory for the customer and deposits the payment in the creditor account.

U.S. Pat. Nos. 6,119,106 and 6,611,818 (both to Mersky et al.) disclose a system for facilitating customer payments to creditors from a remote site including computer systems located at respective agent affiliate, service provider, and creditor sites. The service provider or host computer system is in selective communication with the agent and creditor computer systems and processes any transaction information. A customer typically visits an agent affiliate site and tenders payment in response to receiving a billing statement from a creditor. An agent operator enters all the customer account information and receives payment, applying it to the designated creditor account balance. The payment transaction is entered into the agent system, which, along with other payment transaction information from the agent site, is maintained in a transaction file. The agent system generates a receipt for the customer at the completion of the transaction. Each agent system transfers a transaction file to the host system, and the host system processes the transaction files to generate a closeout report and a creditor report for each creditor indicating the payment activity at the agent sites.

The prior art, however, suffers from several significant disadvantages. Specifically, when a consumer remits payment by check, if the funds are not available in the consumer's account to cover the amount of the check, or if the consumer's account has been closed, then the consumer's bank will return the check to the creditor's bank, which will, in turn, return the check to creditor. The creditor will then have to reverse the transaction crediting the consumer's account in the G/L database and renegotiate payment from consumer, all at significant cost to the creditor. Even if the check clears, the process of providing good funds to creditor is not instantaneous, since the check must physically travel from the creditor's bank to the consumer's bank. If the check doesn't clear, then the creditor and any other parties to the transaction must unwind the payment. Furthermore, payment through the mail not only requires payment of postage, but crates a level of unpredictability, since a consumer does not know when the payment will arrive at the billing institution.

With ATM transactions, the consumer is usually limited to making bill payments only to certain entities specified in advance by the bank, and is required to complete a somewhat onerous registration process for establishing ATM-based bill payment authority or privileges. In addition, a user is not only subjected to severe transaction fees, but also to administrative inefficiencies caused by various billing institutions utilizing different and independent accounts to conduct transactions. In addition, both traditional and ATM systems tend to require the use of pre-existing monetary accounts to conduct transactions remotely, thereby limiting manners of facilitating consumer payment and restricting use of the systems to consumers that can establish the required accounts. Many consumers, moreover, prefer human interaction, being more comfortable tendering payment to an agent of the billing institution rather than a stand-alone computer system.

Furthermore, the prior art systems generally rely on computers or other devices to enable customer payment to creditors by electronically transferring funds between customer and creditor bank accounts. However, these systems are unavailing for customers who do not have a computer or do not have a checking or other bank account. In addition, the prior art systems are typically limited to facilitating customer payment to creditors with a specific type of payment (e.g., electronic fund transfer), and do not accommodate customers that desire, or are only able, to pay creditors with some other form of payment, such as cash. Moreover, a customer using prior art systems typically must authorize and arrange for electronic transfer of funds with the creditor and/or bank in order to enable payment to creditors. This authorization process generally includes submission of various forms by the customer and/or creditor to the customer bank and creditor bank, thereby imposing additional burdens on the parties involved. Although creditors may have offices that are capable of receiving customer payments in various payment forms (e.g., cash), these payments must be received and processed in the creditor's offices during creditor office hours. This is especially distressing for customers that need to make emergency payments (e.g., payments due that day) to avoid lateness and/or other penalties when the creditor's offices are closed.

Additionally, the remote payment system of the Mersky patents, though addressing several of the aforementioned drawbacks, requires an operator to enter the pertinent customer account information, increasing the time the operator must spend with each customer, and increasing the wait times for customers requiring assistance. In addition, an agent operator, when entering customer information into the agent computer system, is more likely to make mistakes since the information is not familiar to the operator. This, in turn, causes further delays in processing the payment. Scanners, though helpful in entering information accurately, are prone to read errors, and have no effectiveness when the customer does not have a bill to scan.

Furthermore, existing, clerk-only systems (i.e., those having no kiosk) do not effectively communicate with the creditors to provide payment by a due date. Many service providers have trustees that collect payments for up to 50 creditors. The host or service providers have various contracted arrangements with each creditor, which often have varying fees, crediting, and posting times, as well as cut-off times, all of which are critical to reinitiate a particular service (e.g., electricity) or to prevent a service disconnect. It is becoming increasingly difficult for service providers to effectively communicate these variations in processing to customers.

Kiosk-only (bill collector) systems require a user to dispense cash directly into the kiosk via a cash acceptor. Since each piece of paper currency must be entered individually, the process is time consuming. In addition, cash acceptors are often unreliable, becoming jammed and preventing the use of the kiosk. Along with cash acceptors, such devices further require change generators, requiring the kiosk to store large amounts of cash and additional processing costs (emptying, counting, and filling the cash within the kiosk). Consequently, kiosks with cash handling are generally expensive, large, are difficult to maintain, and limit the number of transactions that can be taken in a day.

Consequently, there exists a need for a payment system that provides timely (real time) information to a customer and creditors regarding an account, and avoids the problems associated with kiosk (ATM) only systems, and permits tender of payment (e.g., cash) at a remote site without the inefficiencies caused by the aforementioned processes.

### SUMMARY OF THE INVENTION

Accordingly, it is a feature of the present disclosure to facilitate customer payment to creditors with various forms of payment (e.g., check, cash, credit card, etc.) from a remote site (e.g., a local retail establishment).

It is another feature of the present disclosure to facilitate customer payment to creditors from remote sites (e.g., local retail establishments) commonly having substantial business hours, thereby enabling customers to pay creditors from remote sites during respective remote site business hours typically spanning a substantial portion of a day.

Yet another feature of the present disclosure is to facilitate customer payment to creditors from a remote site without requiring the customer to authorize, register for, or pre-arrange the payment transaction with the creditor.

Still another feature of the present disclosure is to reduce payment processing costs for creditors by arranging for a single payment to the creditor for numerous customer accounts.

It is still a further feature of the present disclosure to facilitate tender of payment manually (e.g., tender of payment in the form of cash, check, etc.) for transactions conducted over a network.

It is another feature of the present disclosure to conduct transactions over a network while maintaining consumer anonymity and privacy.

Yet another feature of the present disclosure is to enable consumers without possession of a computer system to conduct transactions over a network.

According to an aspect of the present disclosure, an electronic payment transaction system for enabling customers to pay a plurality of creditors via at least one manual payment to an intermediate trustee at a trustee site includes a trustee processor disposed at the trustee site operable to process the at least one manual payment and to communicate with at least one of a host processor and a kiosk. The electronic payment transaction system includes the kiosk being disposed proximate to the trustee processor to receive batch payment information, from a customer, pertaining to payments to a plurality of creditors, wherein the kiosk communicates with the host processor, and to process the batch payment information pertaining to the payments to the plurality of creditors. The electronic payment transaction system includes a host processor disposed at a service provider site remote from the trustee site and adapted to communicate with the kiosk. The host processor receives the batch payment information from the kiosk.

According to another aspect of the present disclosure, the kiosk further includes a storage to store records corresponding to the at least one manual payment in at least one process transaction file for each of the customers.

According to yet another aspect of the present disclosure, the trustee processor further includes a storage to store records corresponding to the at least one manual payment in at least one payment disbursement file for each of the customers.

According to still another aspect of the present disclosure, the kiosk communicates with a creditor site for each of the plurality of creditors and transmits the batch payment information therebetween.

According to an aspect of the present disclosure, the kiosk further includes a receipt generator to selectively generate at least one printed receipt in response to the payments to the plurality of creditors.

According to another aspect of the present disclosure, the trustee processor further includes a record generator to generate at least one portable record corresponding to the at least one manual payment.

According to yet another aspect of the present disclosure, the host processor is further adapted to communicate with at least one creditor site and transmit a subset of the batch payment information therebetween.

According to still another aspect of the present disclosure, an electronic payment transaction system for enabling customers to pay a plurality of creditors via a plurality of manual payments to an intermediate trustee at a trustee site includes a trustee processor disposed at the trustee site to generate and store at least one record of the plurality of manual payments. The electronic payment transaction system includes a kiosk disposed proximate to the trustee processor to receive batch payment information from a customer pertaining to payments to the plurality of creditors, the kiosk communicating with at least one of the trustee processor and a host processor, and to process the batch payment information pertaining to the payments to the plurality of creditors using the at least one record of the plurality of manual payments. The electronic payment transaction system includes the host processor, disposed at a service provider site remote from the trustee site, that communicates with both the trustee processor and the kiosk. The host processor receives the batch payment information from at least one of the trustee processor and the kiosk.

According to an aspect of the present disclosure, the trustee processor further includes a trustee communication device that transmits the batch payment information to the host processor and the host processor further comprises a receiver that receives the batch payment information from the trustee processor.

According to another aspect of the present disclosure, the trustee processor further includes a portable record generator and the at least one record of the plurality manual payments is stored on at least one portable element generated by the portable record generator.

According to yet another aspect of the present disclosure, a method of enabling a customer of a plurality of creditors to visit a trustee site and manually tender at least one manual payment in response to receiving a creditor statement from each of the plurality of creditors, wherein each of the plurality of creditors is associated with a respective creditor site and the at least one manual payment is tendered at the trustee site and applied to a customer account balance owed to each of the plurality of creditors includes receiving the at least one manual payment at the trustee site from a customer visiting the trustee site and manually tendering the at least one manual payment. The method includes processing, via a trustee processing system disposed at the trustee site, the at least one manual payment and storing at least one record of the at least one manual payment to provide a credited amount. The method includes receiving, via a kiosk disposed proximate to the trustee system, customer account information including the customer account balance owed to each of the plurality of creditors and processing a plurality of creditor payments in which at least a portion of the credited amount is applied to the customer account balance owed to each of the plurality of creditors. The method includes transmitting the customer payment information to a service provider site. The customer payment information includes an amount credited to the customer account balance owed to each of the plurality of creditors. The service provider site is located at a site remote from the trustee site.

According to still another aspect of the present disclosure, processing further comprises generating at least one portable record via the trustee processing system, the at least one portable record indicating at least one of the credited amount and the amount credited to the customer account balance owed to each of the plurality of creditors, and receiving further includes accessing the at least one portable record and applying the portion of the credited amount to at least a portion of the customer account balance owed to each of the plurality of creditors.

According to an aspect of the present disclosure, the method includes transmitting the plurality of creditor payments from the service provider site to the respective creditor site.

According to another aspect of the present disclosure, the trustee processing system provides at least one portable record to the customer.

According to yet another aspect of the present disclosure, the customer provides the at least one portable record to the kiosk to complete processing of the plurality of creditor payments.

According to still another aspect of the present disclosure, the trustee processing system is provided in a first housing and the kiosk is provided in a second housing, and the first housing and the second housing are physically separated from each other.

According to an aspect of the present disclosure, the trustee processing system and the kiosk are collocated, and the first housing and the second housing are collocated.

According to another aspect of the present disclosure, the trustee processor further includes a record generator to generate a single portable record corresponding to a plurality of manual payments and the single portable record is one of: a bar code, a PIN number, and a machine-readable card.

According to yet another aspect of the present disclosure, the at least one record of the plurality manual payments is stored on a single portable element generated by a portable record generator included in the trustee processor, and the single portable record is one of: a bar code, a PIN number, and a machine-readable card.

According to yet another aspect of the present disclosure, the customer provides a single portable record to the kiosk to complete processing of the plurality of creditor payments, and the single portable record is one of: a bar code, a PIN number, and a machine-readable card.

The aforesaid features are achieved individually and/or in combination, and it is not intended that the present disclosure be construed as requiring two or more of the features to be combined unless expressly required by the claims attached hereto.

According to the present disclosure, a system for facilitating customer payment to creditors from a remote site includes a plurality of trustee computer systems each associated with a kiosk. The trustee computer system and the kiosk are both located at the remote (trustee) site (e.g., a local retail establishment). The payment system further includes a host computer system residing at a site associated with a service provider, wherein the host computer system is capable of selectively communicating with both the trustee computer system and the kiosk system in real time.

In operation, a plurality of creditor computer systems typically resides at different sites associated with creditors (e.g., utility or other companies) affiliated or under contract with the service provider, wherein the creditor computer systems are preferably in selective communication with the host computer system for transmitting customer account information. In response to receiving a creditor statement, a customer using the system visits one of the trustee sites (e.g., businesses) and manually tenders payment. Specifically, the customer interacts with the kiosk located at the trustee site to access the creditor account, entering information relating to the customer (name, address, customer account number with the creditor, and/or the amount due). Information of this transaction is saved in a transaction file within the kiosk, which is identified using a personal/process identification number (PIN). The customer receives the PIN and visits a clerk or operator located at the trustee site. The clerk enters the PIN into the trustee computer system. The trustee system communicates with the kiosk, verifying the PIN and accessing the transaction file. The clerk enters the dollar amount tendered by the customer into the trustee computer system, which, in turn, communicates with the kiosk to validate payment and update the transaction file, applying the tendered amount to the account balance due. The kiosk system transmits transaction information to the host computer system.

The host system receives the transaction information from each trustee system and sorts the information. The host system may create a transaction report for each creditor affiliated or under contract with the service provider. Once the transaction reports are generated, the reports are transmitted to the appropriate creditor computer systems in order to credit customer payments to the corresponding customer accounts. Alternatively, the host computer system may generate transaction reports for each creditor affiliated with the service provider, and send the reports to the creditors in any conventional manner (e.g., facsimile, ground transport mail, etc.). Creditors may use the reports to apply the customer payments to the appropriate customer accounts in any conventional manner (e.g., enter the payments into the creditor computer system). The system operator or service provider receives funds from each of the trustees and pays each of the creditors via electronic fund transfer or other conventional payment form. The host system may further generate a closeout report containing transaction information for all transactions occurring at the respective remote sites. The report is typically printed at a predetermined time after all the transaction information has been received from the remote computer systems.

The present disclosure may be additionally utilized for other applications, including but not limited to, receiving a disbursement from a creditor, purchasing money orders, purchasing pre-paid telephone cards, or purchasing additional minutes for a wireless (mobile) phone. The transaction reports may then be sent to the respective money order or telephone companies.

The above and still further features and advantages of the present disclosure will become apparent upon consideration of the following detailed description of a specific embodiment thereof, particularly when taken in conjunction with the accompanying drawings wherein like reference numerals in the various figures are utilized to designate like components.

### BRIEF DESCRIPTION OF THE DRAWINGS

FIG. 1 is a functional block diagram of an exemplary system for facilitating customer payments to creditors from a remote (trustee) site according to the present disclosure.

FIG. 2 is a view in perspective of an exemplary computer system employed by the present disclosure.

FIG. 3 is a view in perspective of an exemplary kiosk device according to an embodiment of the disclosure.

FIG. 4 is a procedural flowchart illustrating the manner in which a customer payment transaction is processed according to the present disclosure.

FIG. 5 is is a procedural flowchart illustrating the manner in which a customer payment transaction is processed according to another embodiment of the present disclosure.

FIG. 6 is an exemplary illustration of a record structure utilized by an agent computer system to maintain customer payment transaction information according to the present disclosure.

FIG. 7 is an exemplary illustration of a creditor report generated by a host computer system containing customer payment transaction information associated with an individual creditor according to the present disclosure.

FIG. 8 is an exemplary illustration of a closeout report generated by a host computer system containing daily customer payment transaction information according to the present disclosure.

FIG. 9 illustrates a system diagram, according to a third embodiment of the present disclosure.

FIG. 10 illustrates a process flow diagram, according to a fourth embodiment of the present disclosure.

### DETAILED DESCRIPTION OF THE PREFERRED EMBODIMENTS

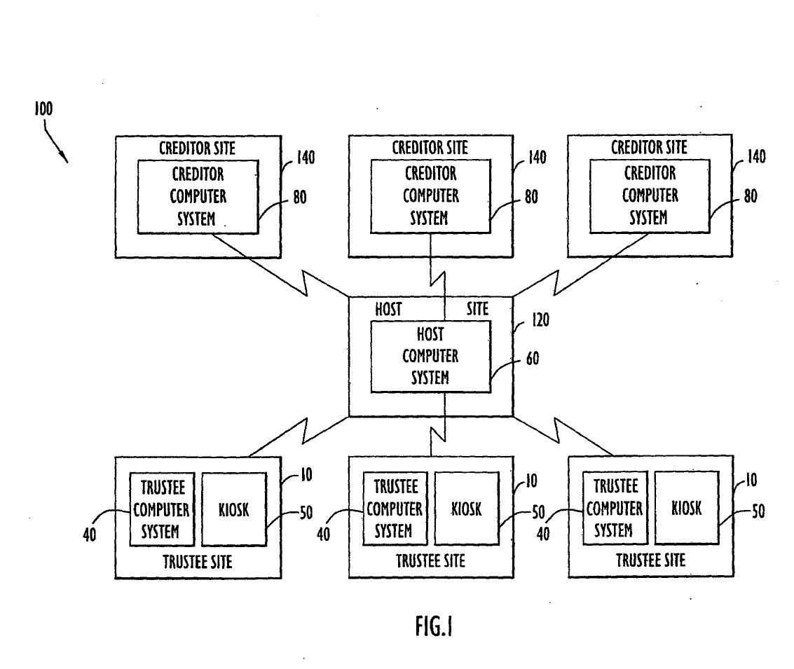

An exemplary system for facilitating customer payments to creditors from a remote site is illustrated in FIG. 1. Specifically, system 100 includes (1) a trustee site 10 (also called an agent site) including a trustee (agent) computer system 40 and a kiosk or creditor transaction device 50; (2) a creditor site 140 including a creditor computer system 80; and (3) a host site 120 (also called a service provider site) including a host computer system (or central database) 60 in communication with at least one of the trustee computer system 40, the kiosk device 50, and the creditor computer system. As shown in FIG. 1, the system typically includes a plurality of creditor sites 140 and a plurality of trustee sites 10 in communication with a single host site 120.

Typically, the service provider arranges for payment to creditors 140 such as utility (i.e., electric, gas, telephone, etc.) or other company sites, and receives processed customer payment transaction information. The service provider further installs the trustee computer systems 40 and the kiosks 50 at the trustee sites 10 (e.g., retail establishments). Finally, the service provider connects the creditor sites 140 and the trustee sites 10 to the host computer system 60. Any communication media may be utilized to connect the host system 60 with the trustee 10 and creditor 140 sites. By way of example, the communication medium may include, DSL connection, cable modem connection, dial-up connection (phone lines), wireless connection (e.g., satellite), and combinations thereof. Information can be sent using transmission methods including, but not limited to, CIE or CTX file format; EDI transmission; MasterCard's RPS process; via a secure FTP; or combinations thereof. Alternatively, host system 60 may send transaction information to the creditor sites 140 in any conventional manner, such as mail, facsimile, or other transport facility.

The trustee computer system 40 is an attended (operated assisted) electronic device adapted to communicate with the host system 60 and the kiosk device 50. The host system 60 is essentially the focal point that receives customer payment transaction information and then processes, stores, and forwards the information to the appropriate creditor and/or trustee systems to enable customer payments to be credited to the corresponding customer accounts. The transaction information is then utilized at respective creditor sites to credit the appropriate customer accounts. Any number of trustees and/or creditors within the communication capabilities of host system 60 may be utilized.

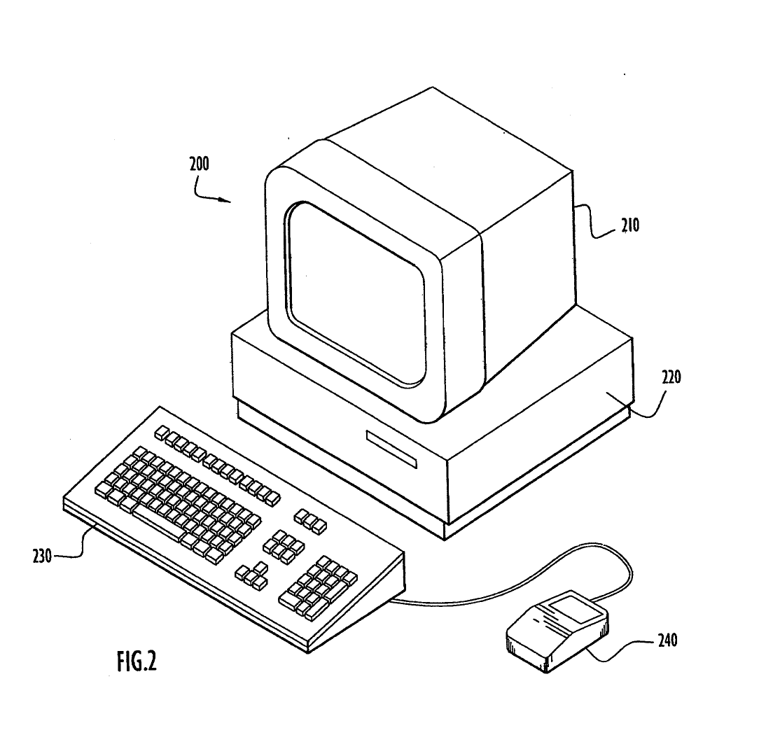

The trustee 40, host 60, and creditor 80 computer systems are preferably implemented by conventional personal computers, or can be larger capacity computers when the data processing requirements necessitate increased processing power. In addition, the trustee system may comprise smaller capacity computer system such as a point of service (POS) device (e.g., a credit card terminal). An exemplary personal computer system for implementing the trustee 40, host 60, and creditor 80 computer systems is illustrated in FIG. 2. Specifically, a computer system 200 may include a conventional IBM-compatible, APPLE-compatible, or other type personal computer preferably equipped with a monitor 210, a base 220 (i.e., including the processor, memory, and internal or external communication devices, ports or modems), a keyboard 230, and a mouse 240. The computer system 200 includes the appropriate software to perform customer payment transaction information processing for any of the trustee 40, host 60, or creditor 60 systems, depending upon the particular utilization of the computer system (i.e., whether the computer system is implemented as a trustee, host or creditor system). The computer system may utilize any of the major platforms or operating systems such as WINDOWS, MACINTOSH, UNIX, DOS or OS2.

The kiosk device 50 (also called a creditor transaction device) is an unattended electronic device capable of receiving input information and generating output information, as well as processing creditor payment information and transactions. The kiosk device 50 is located at the trustee site 10, proximate (e.g., in the same room or building as) the trustee computer system 40. By way of example, the kiosk device 50 may be a computer system in communication with the trustee computer system 40. Specifically, the kiosk device may be linked to the trustee computer system 40, being capable of selectively receiving and/or transmitting information from the trustee system. The kiosk 50 may be directly wired to the trustee computer system 40, or may communicate wirelessly with the trustee computer system. In addition, the kiosk 50 may be adapted to communicate (wired or wirelessly) with the host computer system 60 (i.e., the kiosk uploads and downloads information to/from both the host computer system and the trustee computer system).

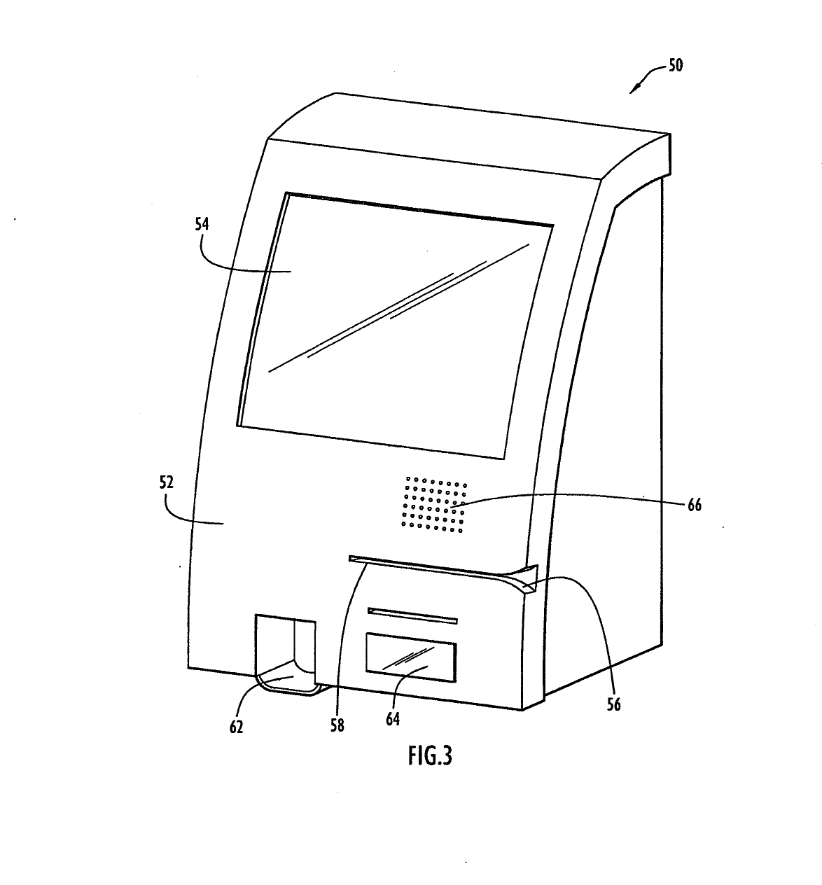

The kiosk 50 is typically a stand-alone device (similar to an ATM device) with software configured to carry out payment transactions. The kiosk 50 may include (1) a display screen; (2) an input device such as a keyboard, a keypad, a trackball, a touch screen, or a voice command unit; (3) a printer; and (4) a scanner (e.g., a card scanner). FIG. 3 illustrates an exemplary kiosk device according to an embodiment of the disclosure. As shown, the kiosk device 50 may include an enclosure 52, a data display 54 (e.g., a surface acoustic wave (SAW) or an LCD touch screen), a magnetic card (or other suitable) reader 56, a smart card reader 58, a printed ticket exit 62, an optical reader 64 (e.g., a barcode reader), and/or a speaker 66. The kiosk device 50 may further house a computer controller (e.g., a small form factor Windows (Pentium) based computer) and a ticket printer (e.g., a three inch thermal printer) (neither shown). Since the payment is tendered manually, it is preferred the kiosk device 50 not include a cash acceptor or dispenser.

As discussed above, a service provider typically obtains authorization from various creditors to receive customer payments for the creditors. The service provider (host) computer system 60 and the creditor computer system 80 are typically configured such that the host system 60 communicates with the creditor system 80 in order to forward to the creditor system 80 customer payment transaction information associated with that creditor. Alternatively, the host system 60 may forward the transaction information to the creditor in any suitable manner, such as mail, facsimile or other transport facilities, and, therefore, may not be configured for communication with creditor systems 80. The service provider also solicits trustees (preferably local retail establishments) to process (collect or refund) customer payments. The service provider typically supplies each trustee with the trustee computer system 40 and the kiosk device 50, including the appropriate software and configuration enabling communication with the host system 60, and thus the processing of customer payments received at the respective trustee site. A service fee may be charged to and paid by customers upon utilizing the payment service; moreover, the service fee can be divided in a prearranged manner between the trustee and service provider. For example, depending on the creditor and the arrangement with the service provider, the customer may pay a fee to the trustee, or the fee may come directly from the creditor. Typically, the trustee collects a service fee at the time of manual payment. The fee due the service provider may be electronically drafted to the service provider from the trustee. Similarly, the amount due the creditor may electronically drafted from the service provider to the creditor, or may be paid using conventional payment methods. Normally, the customer pays a fee for each transaction.

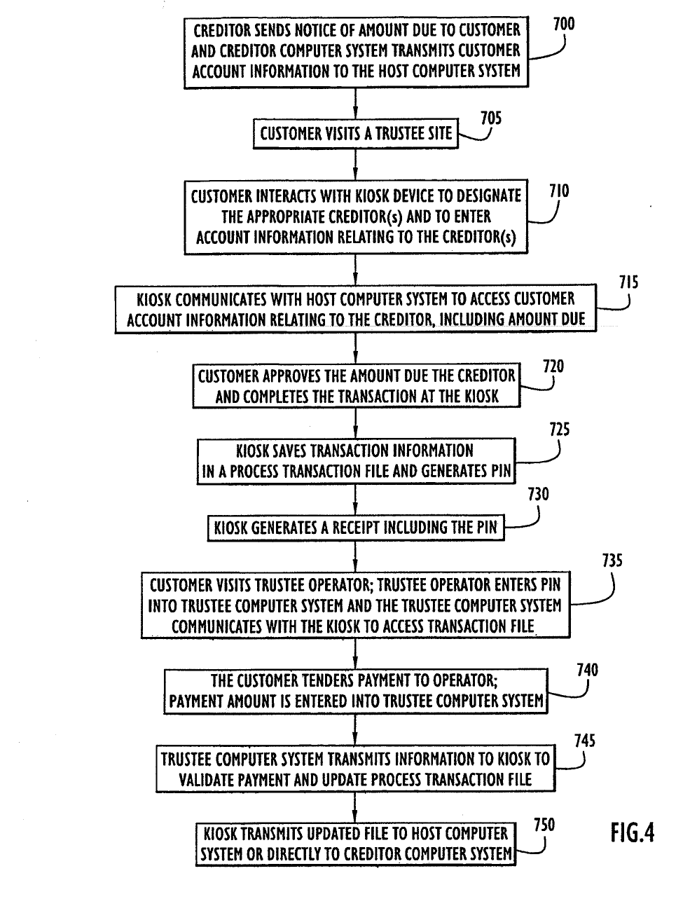

The operation of the system for processing customer payment transactions according to one embodiment of the disclosure is illustrated in FIGS. 1 and 4. Initially, a creditor 140 (Step 700) sends a statement containing account balance information to a customer and requests payment of the balance. In addition, the creditor computer system transmits (downloads) customer account information to the host computer system 60. In response to receiving the creditor statement, the customer visits a trustee site 10 (Step 705). At the trustee site 10, the customer interacts with the kiosk device 50 to designate the creditor, as well as to enter account information relating to the creditor (Step 710). For example, the customer may use interactive software that directs the customer through the payment process to select the creditor and the product that requires payment, allowing the customer to select a creditor from a list displayed by the kiosk 50 and entering the customer account number for that creditor. Alternatively, the customer may enter information than the account number to access the account information (e.g., name, address, etc.). Furthermore, the customer may scan the creditor statement into the kiosk (if the creditor statement contains machine-readable indicia). The scanner may be any type of scanner capable of gathering input in any coded or uncoded format, such as a bar code reader or optical character recognition scanner. Similarly, the creditor statement may be generated for compatibility with the particular scanner employed by the trustee system. For example, when a bar code scanner is being employed by the trustee system, the creditor statement includes bar codes in prescribed fields containing the relevant information such that the bar code scanner reads the information directly from the creditor statement into the trustee system. Alternatively, the information may be alphanumeric characters disposed in prescribed fields, and readable by the scanner and computer arrangement.

The kiosk 50, in response to the customer input, communicates with the host computer system 60 to access (download) the customer account information relating to the pertinent creditor, including the amount due. This is indicated at Step 715. Alternatively, the kiosk 50 may communicate directly with the creditor computer system 80. The customer approves the amount due the creditor and completes the transaction at the kiosk 50 (Step 720). Upon completion, the kiosk saves a record of the transaction in a process transaction file, identifying the transaction with, for example, a process/personal identification number (PIN) (Step 725). The kiosk 50 may also generate a printed record, such as a receipt including the PIN (Step 730).

The customer then visits a clerk or operator at the trustee site 10 to tender manual payment. Specifically, the trustee operator enters the PIN into the trustee computer system 40 (Step 735). The trustee computer system 40, in response, communicates with the kiosk 50 to verify the PIN and access (download) the process transaction file. The customer tenders the payment (e.g., via cash) to the trustee operator, who enters the amount into the trustee computer system 40 (Step 740). Once entered, the trustee computer system 40 transmits (uploads) information to the kiosk 50 to validate payment and update the process transaction file (Step 745). At Step 750, the kiosk 50 then transmits the updated file to the host computer system 60 (or if the initial transaction file was sent previously, updates the transaction file with payment validation). Alternatively, the kiosk 50 may communicate directly with the creditor computer system 80 to transmit the updated file. The trustee computer system 40 may then generate a printed record of payment such as a receipt.

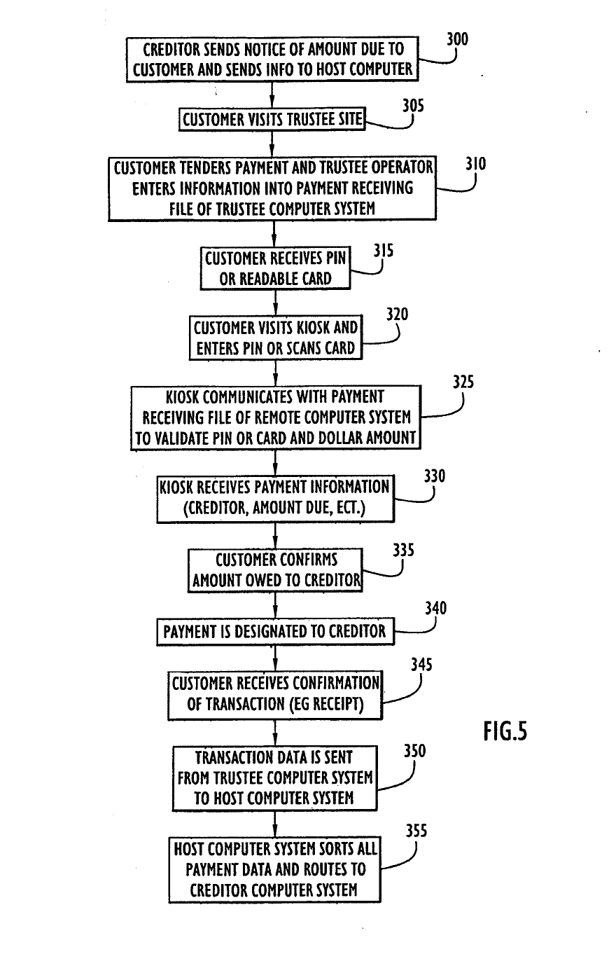

The operation of the system for processing customer payment transactions according to another embodiment of the disclosure is illustrated in FIGS. 1 and 5. FIG. 5 is a procedural flow chart illustrating the manner in which a customer payment transaction is processed according to an embodiment of the disclosure, where a balance is due to a creditor, but initially interacts with the trustee operator prior to interacting with the kiosk 50. As with above embodiment, a creditor 140 (Step 300) sends a statement containing account balance information to a customer and a requests payment of the balance and transmits corresponding customer account information to the host computer system 60. The customer visits a trustee site 10 (Step 305) to manually tender payment (e.g., paying cash) to the trustee operator. The trustee operator enters the payment/transaction information into the trustee computer system 40, which processes and maintains the information in a payment receiving area (i.e., a payment transaction file). This is indicated at Step 310. Once the payment is tendered and the transaction information processed, the trustee system 40 generates a payment verification record for that customer transaction (Step 315). The record may be a personal identification number (PIN). Alternatively, the system 40 could generate a portable element capable of storing information such as a magnetic card (e.g., at ATM card) or other computer/scanner readable element. The operator provides the payment verification record (i.e., PIN/card) to the customer. At Step 320, the customer visits the kiosk device 50 that is associated with and located proximate to the trustee computer system 40. As explained above, the kiosk device 50 is typically located at the same site where the payment is made (i.e., at the trustee site 10).

The customer initially interacts with kiosk 50 by authorizing the payment process. Specifically, the customer enters the assigned PIN (or has the kiosk 50 scan the readable element). The kiosk device 50 communicates with the payment receiving area of the trustee computer system 40 to validate the PIN (or the readable element) and identify the dollar amount present in the account (i.e., the dollar amount tendered to the trustee/operator) (Step 325).

At Step 330, the kiosk 50 communicates with the host computer system 60 to access creditor payment information relating to the customer. The kiosk 50 may include interactive software that directs the customer through the payment process to select the creditor and the product that requires payment. For example, the customer may initiate the “Customer Bill-Pay” function wherein the kiosk device 50 displays a customer payment screen including fields to receive the customer name, customer identification number, and/or a customer address (i.e., street, city, state and zip code wherein the screen includes fields for receiving such information). In addition, screen may include a listing of creditors from which a specific creditor (e.g., utility or other company) may be chosen. Once chosen, the customer may enter the appropriate customer account number and the amount to be paid to the creditor. The particular layout of the screens for input of information is not particularly limited, and may include those disclosed by U.S. Pat. No. 6,611,818 (Mersky et al), incorporated herein by reference in its entirety. The types of products are not limited. By way of example, it may include bill payment (creditor or utility bills), wire transfers, or prepaid products such as gift cards, phone cards, or wireless phones.

Alternatively, if the creditor statement includes machine-readable information, the customer may have the bill read (e.g., by inserting the bill into a reader/scanner) to retrieve payment information. Specifically, customer payment processing may be performed in substantially the same manner described above except that the customer and other related information may be entered into kiosk device 50 utilizing a scanner. The scanner reads the relevant customer information from the creditor statement, thereby facilitating automatic entry of customer and other related information (e.g., amount due to the creditor, account numbers, creditor name, customer name and address, etc.) into the kiosk device 50 (and thus the trustee computer system 40). The scanner may be any type of scanner capable of gathering input in any coded or uncoded format, such as a bar code reader or optical character recognition scanner. Similarly, the creditor statement may be generated for compatibility with the particular scanner employed by the trustee system. For example, when a bar code scanner is being employed by the trustee system, the creditor statement includes bar codes in prescribed fields containing the relevant information such that the bar code scanner reads the information directly from the creditor statement into the trustee system. Alternatively, the information may be alphanumeric characters disposed in prescribed fields, and readable by the scanner and computer arrangement.

The kiosk software displays the amount owed. Optionally, the computer system of kiosk device 50 may provide the customer with an opportunity to confirm the amount due (to ensure its accuracy) (Step 335). The customer approves the payment, designating all or part of the amount indicated in the payment transaction file be applied to a specific creditor balance. At Step 340, the payment transaction is completed, with the transaction information being communicated to the trustee computer system 40 (that the appropriate amount may be deducted from the payment transaction file). The customer then receives confirmation that the transaction is completed (i.e., that the bill has been paid) at Step 345. As discussed above, the kiosk 50 may include a printer that generates a receipt recording the transaction and confirming that payment was tendered. The type of receipt is not limited, an may include those disclosed in U.S. Pat. No. 6,611,818 (Mersky et al), incorporated herein by reference in its entirety.

Once the creditor transaction is processed, the kiosk 50 communicates with the trustee computer system 40, transmitting the transaction data to the trustee computer system 40 to update account information (i.e., that a balance has been applied to a product account). The transaction data is transmitted (typically in real time) from the trustee computer system 40 to the host computer system 60 (via internet, dial-up, etc) (Step 350) (discussed in greater detail below). Alternatively, the kiosk 50 may transmit the information directly to the host computer system 60. Finally, at Step 355, the host computer 60 sorts all incoming payments and routes them to the appropriate creditor 140. Any or all the steps of this process may then be repeated as necessary with remaining products and account balances.

In an alternate embodiment, kiosk device 50 may be used to disburse a payment to a customer. Initially, a creditor 140 sends a statement to a customer, indicating an amount is owed to the customer. Accordingly, the creditor system 80 transmits information to the host computer system 60, indicating an amount is owed to a customer. The host computer system 60, in turn, communicates this information to either the trustee computer systems 40 the kiosk 50, or both. Each system stores the information in a payment disbursement file. The customer visits a trustee site 10 and interacts with the kiosk 50, entering identifying information (e.g., name, social security number, etc.), or using the kiosk scanner to read the payment notice. The kiosk 50 communicates with the trustee computer system 40 or the host computer system 60 to validate the amount due the customer (i.e., to access the customer record in the payment disbursement file). The software may further verify the identity of the customer (e.g., via security questions such as date of birth, mother's maiden name, etc). Once the identity of the customer and the amount owed the customer is validated, the kiosk 50 provides a disbursement verification record. The record may include a receipt printed by the kiosk 50 that indicates account information, for example, a PIN number and the payment amount. Alternatively, the kiosk may generate a machine-readable element (e.g., a receipt with a bar code or a card). The kiosk 50 stores this information, or sends it to the trustee computer system 40 for storage in the payment disbursement file. The customer may then take the payment verification record to an operator located at the trustee computer system 40. The trustee operator processes the record using the trustee computer system 40 and pays the amount due the customer. Specifically, the operator may verify the amount due by supplying the identification number printed on the receipt generated by the kiosk 50, or by scanning the readable card or bar code. During the verification, the trustee computer system 40 extracts the appropriate information from a payment disbursement file. The operator may further require proof of customer identification, etc. Once processed, the operator may provide a receipt indicating that payment has been received. The trustee computer system 40 then transmits the payment information to either the host computer 60 and/or the kiosk device (which, in turn, transmits the information to the host computer system). The host processor 60 then processes the information and directs it to the appropriate creditor system 80.

The trustee system 40 and/or kiosk 50 may repeatedly process customer payments as described above. At the completion of each payment transaction, the trustee computer system 40 transmits the transaction (a payment received or disbursed) to the host computer system 80. Once the trustee system 40 or kiosk 50 establish a connection to the host system 60, the trustee system 40 transfers a file containing the transaction information.

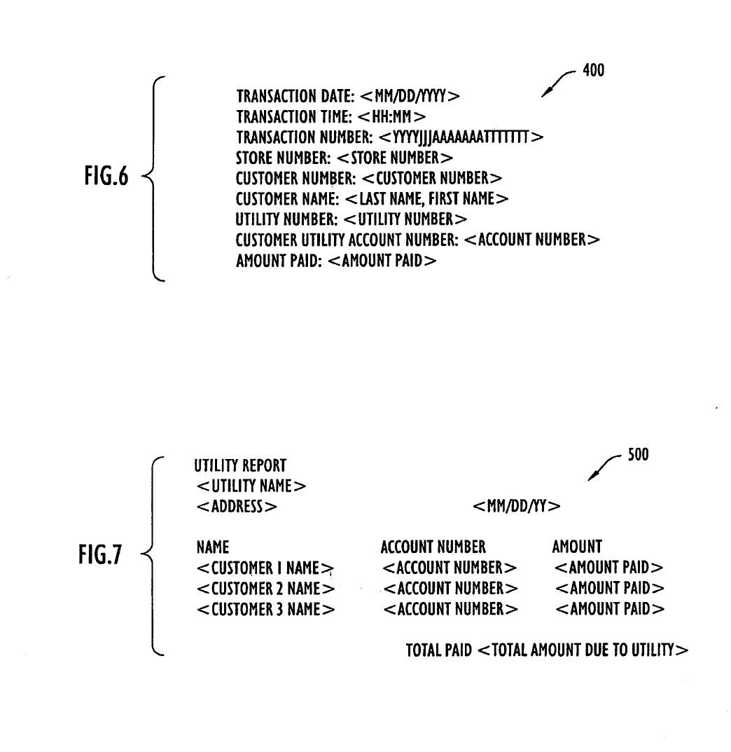

The transaction file includes a plurality of records, with each record having information pertaining to a particular transaction as illustrated, by way of example, in FIG. 6. The text delineated by brackets ‘< >’ in the Figure indicates the type of information appearing in a record field. Specifically, a record 400 contains information relating to the transaction date (e.g., in an MM/DD/YYYY format as described above) and time (e.g., in an HH:MM format wherein H indicates the hour and M indicates the minute), the transaction number (e.g., in a YYYYJJJAAAAAAATTTTTTT format wherein Y indicates the year, J indicates the day of the year, A indicates the trustee number and T indicates the transaction number), the trustee number, the customer name (e.g., last name, first name), the customer identification number described above, the creditor number (i.e., a number identifying a particular creditor), the customer account number and the amount paid by the customer.

Upon receipt of the payment transaction information from each trustee system, the host system may generate a creditor report for each individual creditor as illustrated, by way of example, in FIG. 7. The text delineated by brackets ‘< >’ in the Figure indicates the type of information appearing in the report field as described above. Specifically, the host system 60 receives a transaction file from each trustee system 40 as described above. The host system 60 examines each record 400 (FIG. 5) in the file and retrieves the creditor, customer name, customer account, and amount paid information. The host system 40 then sorts the retrieved information based on the particular creditor such that all transactions related to a specific creditor are grouped together to form an individual report. The individual reports for the respective creditors affiliated with the service provider may contain information relating to the creditor name and address, the date (e.g., in an MM/DD/YY format as described above) of the report, a table including the customer transactions for the creditor, and the total amount due to the creditor. The table may include column headings indicating the customer name, customer account number, and amount paid, while each table row indicates a customer payment and specifies the amount a particular customer paid to the creditor. The host system 60 may automatically calculates the total amount due to the creditor and places the amount in the creditor report below the table. When a report is generated by the host system 60 for each creditor affiliated with the service provider, the reports are sent to the appropriate creditors. The reports are typically sent to the creditors via communications between host system 60 and creditor systems 80. However, the host system 80 may send the reports to the creditors in any conventional manner, such as mail, facsimile or other transport facilities. The service provider subsequently remits payment to the respective creditors in accordance with the creditor report totals via check, electronic fund transfer, or in any other agreed upon conventional manner.

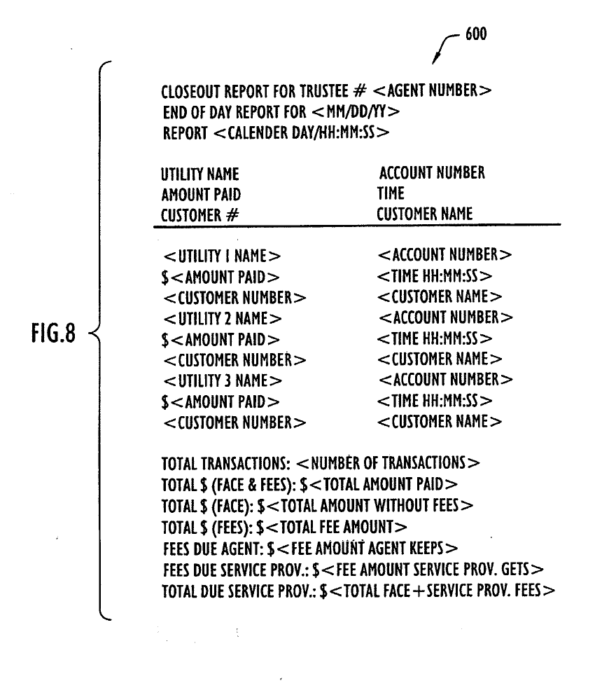

After the creditor reports 500 are generated, the host system 60 may determine whether or not a predetermined reporting time (e.g., the end of the day) has arrived. When the host system determines that the end of the day has arrived, the host system may generate a closeout report 600 as illustrated by way of example in FIG. 8. The text delineated by brackets ‘< >’ in the Figure indicates the type of information appearing in the report field as described above. The closeout report 600 is generated based on the information in the transaction files received from each trustee system 40. Specifically, the closeout report 600 includes information related to each respective trustee site 10. The information included in the report for each respective trustee site is related to the trustee number, the day for which the report is generated (e.g., in an MM/DD/YY date format as described above), the date (e.g., the calendar day) and time (e.g., in an HH:MM:SS format described above) that the report is generated, and for each transaction at the respective trustee site, the creditor name, the customer account number, the amount paid, the time (e.g., in an HH:MM:SS format described above) of the transaction, the customer name and the customer identification number. In addition, the host system 60 calculates totals pertaining to the payment transactions based on the relevant information in the transaction files, wherein the closeout report 600 further includes for each respective trustee site 10 the total number of transactions, the total amount paid by customers (and/or to customers) including service fees (i.e., total of face amounts and service fees), the total amount paid by customers excluding service fees (i.e., the total face amount), the total amount of service fees (e.g., the service fees due to the trustee and service provider), and the total amount due to the service provider (i.e., amount of customer payments and the portion of the fees due to the service provider). In accordance with the closeout reports, the service provider deducts or remits payment from/to the trustees' bank accounts via the host computer system 60 or other device, or receives/remits payments from the trustees in any other conventional pre-arranged manner.

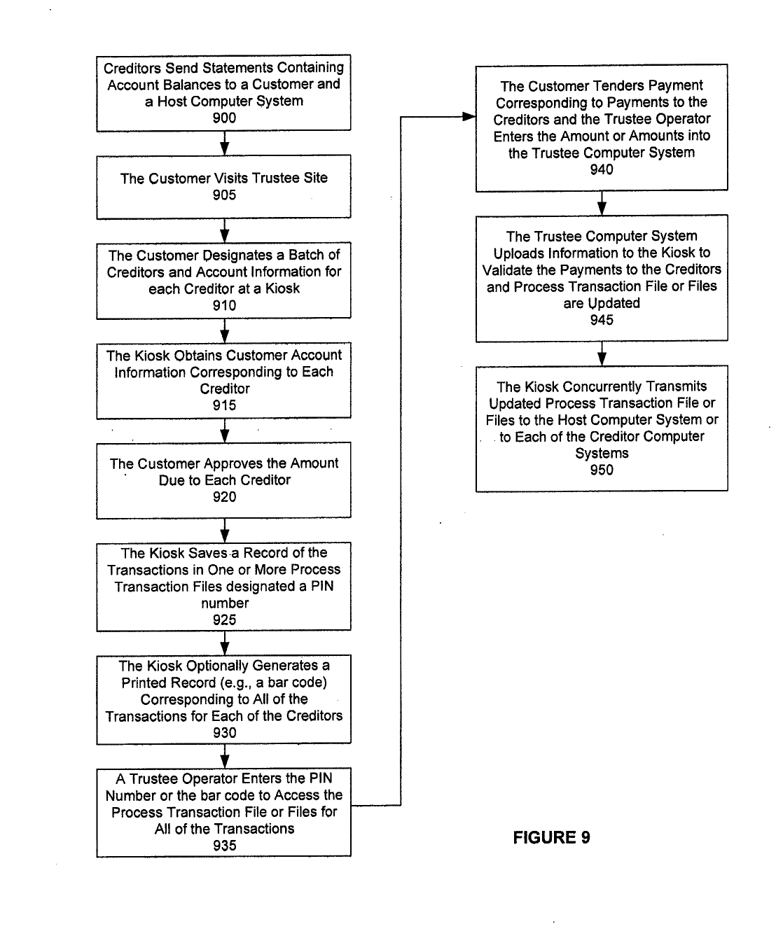

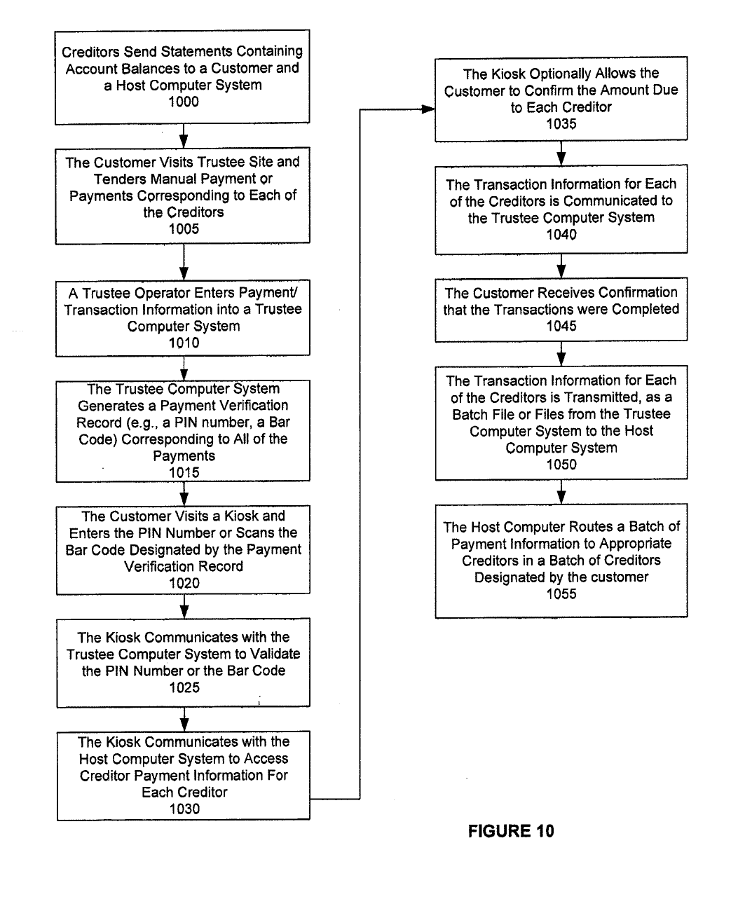

In one non-limiting embodiment of the present disclosure as shown in FIGS. 9 and 10, a bill payment transaction is initiated when a number of creditors send statements containing account balance information to a customer and request payment of each of the respective balances in Step 900. The types of transactions and products are not limited. By way of example, transactions may include bill payment (e.g., creditor bills and utility bills), wire transfers, purchasing products or services (e.g., clothing, electronics, grocery delivery) or purchasing prepaid products (e.g., gift cards, phone cards, coupons or wireless phones).

Returning to the bill payment transaction, computer systems corresponding to one or more of the creditors transmit (or download) customer account information to the host computer system, also known as an aggregator. As will be understood by one of ordinary skill in the art, a number of different statements may be received from a single creditor and a payment is applied to one or more of the customer accounts with the single creditor. In response to receiving the creditor statements, the customer visits a trustee site in Step 905. At the trustee site, the customer interacts with the kiosk device to designate a batch of creditors (i.e., corresponding to the statements received in Step 900), as well as to enter account information relating to each creditor in Step 910. As discussed above with respect to FIG. 4, the customer may use interactive software, enter account numbers to access account information, or scan the creditor statements received in Step 900.

In response to the customer input, the kiosk communicates with the host computer system, or in an alternative embodiment, the creditor computer systems, to access (download) the customer account information relating to each of the pertinent creditors designated in Step 910, including the amount due to each creditor, in Step 915. The kiosk obtains the customer account information from each of the creditor computer systems via a request unit to each of the creditors. In the alternative embodiment, the kiosk obtains the customer account information from the host computer system by providing a batch list of the creditors designated by the customer to the host computer system.

In Step 920, the customer approves the amount due to each the creditor in succession, and completes the transactions at the kiosk. For example, if the customer receives three creditor statements, the customer can approve three amount due totals (or fewer amount due totals if the customer chooses to pay only a subset of the creditors sending creditor statements). Upon completion, the kiosk saves a record of each of the transactions in one or more process transaction files, identifying the transactions with, for example, a PIN number in Step 925. In one non-limiting embodiment of the present disclosure, the PIN number is a concatenation of PIN or access numbers specific to the customer and each creditor and one process transaction file is generated and stored for all the creditors (irrespective of the number of creditors the customer designates to pay). In another non-limiting embodiment of the present disclosure, the kiosk generates a single bar code corresponding to all of the creditors (irrespective of the number of creditors the customer designates to pay). That is, the single bar code represents a multi-payment transaction (or, in a purchasing transaction, a multi-product transaction). The embodiments in which a single bar code or the concatenation of PIN or access numbers are generated assist either or both a retailer or creditor to associate a customer loyalty program or a discount program to the multi-payment or the multi-product transaction. More particularly, the retailer or the creditor would only need to store information related to the single bar code or the single concatenated PIN as opposed to storing a number of bar codes and a number of PINs for the customer. The host computer system, also known as the aggregator, can also charge higher fees for multi-product and multi-payment transactions. In another non-limiting embodiment, a process transaction file is generated and stored for each creditor and each process transaction file includes a unique bar code number specific to each creditor or bill payment. In yet another non-limiting embodiment of the present disclosure, a process transaction file is generated and stored for each creditor and each process transaction file includes a unique PIN number specific to each creditor or each bill payment. The kiosk may also generate a printed record (e.g., a printed receipt) or a portable record (e.g., storable on an electronic device) including the PIN number or PIN numbers or the single bar code or multiple bar codes for the creditors in Step 930.

The customer then visits a clerk or operator at the trustee site to tender a manual payment or payments. Specifically, the trustee operator enters the concatenated PIN number or scans the single bar code into the trustee computer system in Step 935. If there are a number of process transaction files each designated with the unique PIN number (or bar code) specific to each creditor, then the trustee operator enters each unique PIN or scans each unique bar code into the trustee computer system. The trustee computer system, in response, communicates with the kiosk to verify the concatenated PIN number (or the single bar code) or the unique PIN numbers (or the unique bar codes) and accesses (downloads) the process transaction file or the process transaction files. The customer tenders the payment (e.g., via cash) to the trustee operator, who enters the amount into the trustee computer system in Step 940. In one non-limiting embodiment of the present disclosure, a single payment is tendered and the single payment tendered by the customer corresponds to the sum of all the amount due totals (i.e., the sum of the amount due to each of the creditors designated to be paid). In another non-limiting embodiment of the present disclosure, the customer tenders payment for each creditor individually; in such case, Steps 940 and 945 are repeated, in succession, for each creditor.

Once entered, the trustee computer system transmits (uploads) information to the kiosk to validate the payment and to update the process transaction file or process transaction files in Step 945. At Step 950, the kiosk then transmits the updated process transaction file or concurrently transmits the updated process transaction files to the host computer system 60 (or if the initial process transaction file or files was sent previously, the kiosk updates the process transaction file or files with payment validation). Alternatively, the kiosk may concurrently communicate directly with each creditor computer system designated by the customer to transmit the updated process transaction file or files. The trustee computer system may then generate a printed record of the single payment or the multiple manual payments (e.g., a receipt).

FIG. 10 is a procedural flow chart illustrating the manner in which a single customer payment or multiple customer payments are processed according to another non-limiting embodiment of the present disclosure in which a balance is due to a number of creditors, but the customer initially interacts with the trustee operator prior to interacting with the kiosk. As with above-described embodiment, a number of creditors send statements containing account balance information to a customer, request payment of the appropriate account balance and transmit corresponding customer account information to the host computer system in 1000. Also as discussed above, the types of transactions and products are not limited. By way of example, transactions may include bill payment (e.g., creditor bills and utility bills), wire transfers, purchasing products or services (e.g., clothing, electronics, grocery delivery) or purchasing prepaid products (e.g., gift cards, phone cards, coupons or wireless phones). Returning to the bill payment transaction, the customer visits a trustee site in Step 1005 to manually tender payment (e.g., cash) to the trustee operator. In one non-limiting embodiment of the present disclosure, a single payment is tendered and the single payment tendered by the customer corresponds to the sum of all the amounts due to the each of the creditors. In another non-limiting embodiment of the present disclosure, the customer tenders payment for each creditor individually; in such case, Steps 1010 and 1015 are repeated, in succession, for each creditor. The trustee operator enters the payment/transaction information into the trustee computer system, which processes and maintains the information in a payment receiving area (i.e., one or more payment transaction file) in Step 1010.

As discussed above, the customer may tender a single payment corresponding to amounts due to all of the creditors, or may tender individual payments corresponding a single amount due to each individual creditor. Once the single payment or the multiple payments are tendered and the payment/transaction information is processed, the trustee system generates one payment verification record corresponding to the single payment or multiple payment verification records corresponding to the multiple payments in Step 1015. The payment verification record may include a concatenated PIN number or a single bar code, as set forth above, or may include a unique PIN (or a unique bar code) specific to each creditor, as discussed above. Alternatively, the trustee system generates a portable element or elements capable of storing information such as a magnetic card (e.g., an ATM card) or other computer/scanner readable element or elements. The operator provides the payment verification record or records (i.e., the PIN number(s), the bar code(s) or the portable element(s)) to the customer. At Step 1020, the customer visits the kiosk device that is associated with and located proximate to the trustee computer system. As explained above, the kiosk device is typically located at the same site where the payment or payments are made (i.e., at the trustee site).

The customer interacts with the kiosk to authorize the payment process. Specifically, the customer enters the PIN number or numbers. Alternatively, the customer scans a single bar code or a multiple bar codes. The kiosk device communicates with the payment receiving area of the trustee computer system 40 to validate the PIN number or numbers, the single bar code or the multiple bar codes (or other portable element or elements) and identify the monetary amount present in the account (i.e., the dollar amount tendered to the trustee/operator) in Step 1025.

At Step 1030, the kiosk communicates with the host computer system to access creditor payment information, for each creditor, relating to the customer. Once chosen, the customer may enter the appropriate customer account numbers, corresponding to each creditor, and the amount to be paid to each creditor. As discussed above, the particular layout of the screens for input of information is not particularly limited, and may include those disclosed by U.S. Pat. No. 6,611,818 (Mersky et al.), incorporated herein by reference in its entirety.

The kiosk software displays the amount owed to each creditor. Optionally, the computer system of the kiosk device may provide the customer with an opportunity to confirm the amount due (to ensure its accuracy) to each creditor in Step 1035. The customer approves the payment, designating all or part of the amount indicated in the payment transaction file or files to be applied to one or more specified creditor balances. Step 1035 is repeated for each creditor selected by the customer. At Step 1040, the payment transaction is completed, with the transaction information being communicated to the trustee computer system (so that the appropriate amount may be deducted from each of the payment transaction files corresponding to each creditor). The customer then receives confirmation that the transaction is completed (i.e., that each creditor bill has been paid) at Step 1045. As discussed above, the kiosk may include a printer that generates a receipt recording the transaction and confirming that payment was tendered. As discussed above, the type of receipt is not limited, and may include those disclosed in U.S. Pat. No. 6,611,818 (Mersky et al).

Once the creditor transactions are processed, the kiosk communicates with the trustee computer system, transmitting the transaction data to the trustee computer system to update account information (i.e., that a balance has been applied to one or more product account) for each creditor. In one non-limiting embodiment of the present disclosure, the transaction data is submitted as a batch of data for all of the selected creditors. In another non-limiting embodiment of the present disclosure, the transaction data is individually submitted for each of the selected creditors. The transaction data is transmitted, as a batch file or files, (typically, in real time) from the trustee computer system to the host computer system (e.g., via the Internet, an intranet) in Step 1050, which is discussed in greater detail below. Alternatively, the kiosk may transmit the information directly to the host computer system. In Step 1055, the host computer sorts all incoming payment information and routes a batch of payment information to appropriate creditors in a batch of creditors designated by the customer. Any or all the steps of this process may then be repeated as necessary with remaining products and account balances.

In an alternative embodiment, the kiosk device may be used to disburse one or more payments to a customer. Initially, creditors send statements to customers, indicating an amount is owed to the customer. Accordingly, the creditor system or systems transmit information to the host computer system, indicating an amount is owed to a customer. The host computer system, in turn, communicates this information to either the trustee computer systems, the kiosk, or both. Each system stores the information in one or more payment disbursement files. In one non-limiting embodiment of the present disclosure, each payment disbursement file corresponds to a unique creditor. In another non-limiting embodiment of the present disclosure, one payment disbarment file corresponds to all the creditors. The customer visits a trustee site and interacts with the kiosk, entering identifying information (e.g., name, social security number, etc.), or using the kiosk scanner to scan the payment notice. If the customer has received more than one payment notice from different creditors, then the payment notices are scanned in succession. The kiosk communicates with the trustee computer system or the host computer system to validate the amount due or amounts due to the customer (i.e., to access the customer record in the payment disbursement file or files). The software may further verify the identity of the customer (e.g., via security questions such as date of birth, mother's maiden name, etc). Once the identity of the customer and the amount owed the customer is validated, the kiosk provides one or more disbursement verification records. In one non-limiting embodiment of the present disclosure, a disbursement verification record is generated and stored for each individual creditor. In another non-limiting embodiment of the present disclosure, a disbursement verification record is generated and stored for all of the creditors. The disbursement verification record may include a receipt printed by the kiosk that indicates account information, for example, PIN number(s) (i.e., corresponding to one or more creditors) and the payment amount or payment amounts (i.e., corresponding to the one or more creditors). Alternatively, the kiosk may generate a machine-readable element or elements (e.g., a receipt with a single bar code or a card) corresponding to all of the creditors. In one non-limiting embodiment of the present disclosure, a machine-readable element (e.g., a receipt with a single bar code or a card) is generated for each individual creditor. The kiosk stores this information, or sends it to the trustee computer system for storage in the payment disbursement file or files. The customer may then take the payment/disbursement verification record or records (e.g., the one or more bar codes, cards or PIN number) to an operator located at the trustee computer system. The trustee operator processes the record or records using the trustee computer system and pays the amount due to the customer. That is, the trustee operator pays all of the amounts due from each creditor as a batch payment. Specifically, the operator may verify the amount due by supplying the PIN number or numbers printed on the receipt generated by the kiosk, or by scanning the machine-readable element (e.g., the card or bar code). In another non-limiting embodiment of the present disclosure, a PIN number, bar code, card or other machine-readable element unique to each creditor, is entered or scanned, in succession. During the verification, the trustee computer system extracts the appropriate information from the payment disbursement file or files. The operator may further require proof of customer identification, etc. Once processed, the operator may provide a receipt or receipts indicating that payment has been received by the customer. The trustee computer system then transmits the payment information to either the host computer and/or the kiosk device (which, in turn, transmits the information to the host computer system). The host processor then processes the information and directs it to the appropriate creditor system.

In one non-limiting embodiment of the present disclosure, the trustee system and/or kiosk may repeatedly process customer payments as described above. At the completion of each payment transaction, the trustee computer system transmits the transaction (a payment received or disbursed) to the host computer system. Once the trustee system or kiosk establish a connection to the host system, the trustee system transfers a file containing the transaction information. In another non-limiting embodiment of the present disclosure, the trustee system and/or kiosk may processes a batch of payments to the customers together. At the completion of all of the payment transactions corresponding to each of the creditors, the trustee computer system transmits a batch of transaction data (i.e., corresponding to one or more payments received or disbursed) for each of the creditors to the host computer system. Once the trustee system or kiosk establish a connection to the host system, the trustee system transfers one or more files containing the batch of transaction data.

It will be appreciated that the embodiments described above and illustrated in the drawings represent only a few of the many way of implementing the customer payment system of the present disclosure. For example, the kiosk 50, in addition to communicating with the trustee computer system 40, may also communicate directly with the host computer system 60. In addition, the transaction information may be transmitted (uploaded/downloaded) from one computer system (creditor, trustee, and host) to another at any time throughout the process. In certain configurations, the kiosk device 50 may transmit and access information directly from the creditor computer system 80. Similarly, information may be stored in any of the kiosk device 50, the trustee system 40, and/or the host system 60. In addition, an intermediate processor may be utilized wherein the intermediate processor (e.g., a Mastercard RPPS) takes payment data from the host computer system 60 and transmits the data to the creditor computer system 80.

The time at which the transaction is transmitted is not particularly limited, and can be transmitted at any point during the payment transaction. For example, date may be transmitted in real time. In addition, date may be transmitted at predetermined intervals (e.g., on an hourly or daily basis), sending updates as warranted. In addition, in one embodiment, trustee system 40 and/or kiosk 50 may determine whether or not the transaction information has been transmitted to the host system 60 within a predetermined time interval. In the event that the trustee system 40 and/or kiosk 50 determines that the information has not been transferred to the host system, the trustee system and/or kiosk may automatically disable itself, precluding it from processing further customer payment transactions until the appropriate system is reset.

Additionally, the number of bills paid during a transaction is not limited. That is, the customer can tender payment for multiple bills during a single transaction. Similarly, during a kiosk interaction, the customer could designate payment to more than one creditor. The kiosk device 50 may tabulate the entire amount owed to various creditors, indicating a total amount due to the trustee operator. The method of payment, though typically cash, may also include check, money order, credit cards, etc. Additionally, the customer may include an electronic debit account with the trustee, wherein the account is deducted automatically by designation of the customer.

The computer systems may be implemented by any type of computer system (e.g., personal computer, mini or microcomputer, microprocessor, main frame, etc.) or processor and monitor capable of processing and communicating transaction information. Further, the host system may be implemented by a mainframe having terminals located at the trustee sites wherein the mainframe does all the processing of payment information on-line as the information is entered at the terminals, the processing being carried out in substantially the same manner described above. The creditor computer systems may also be mainframe computers utilized by the creditor to process customer accounts wherein the creditor reports may be sent to the mainframe from the host system for automatic updating of customer accounts. Alternatively, the creditor computer system may be a personal or other computer system for receiving the creditor report from the host system, wherein the receiving computer may either transmit the report to a creditor processing system for updating customer accounts, or print the report for data entry into the creditor processing system. The computer system screens may be arranged in any fashion and contain any desired information. Further, the screens may be implemented by windows, graphical user interfaces, line prompting, or any other data entry and display techniques. Moreover, any keystroke or input device may be utilized to initiate the various screen functions (e.g., mouse, voice, etc.). Communications between the computer systems may be accomplished by any techniques capable of transmission and reception of the transaction information. The creditor reports may be sent to the creditor from the service provider site via the creditor and host computer systems or any other transport method, such as facsimile (e.g., host system to facsimile or faxing a hard copy of the report), or mailing or transporting hardcopy of the report to the creditor.

The software for the present disclosure may be implemented in any of a number of computer programming languages. It is to be understood that one of ordinary skill in the computer arts can develop the software based on the foregoing description and flow charts.

The trustee systems may employ any type of scanner for reading information directly from a billing statement or other form wherein the creditor billing statements or other forms may be printed or encoded in any manner capable of being read by any type of scanner utilized by the trustee system for system data entry. The transaction information may be stored in a database, file, data structure or any other software construct capable of maintaining transaction information.

From the foregoing description it will be appreciated that disclosure makes available a novel method and apparatus for facilitating customer payments to creditors from a remote site wherein the system facilitates customer payments in any payment form (e.g., cash, credit card, etc.) to various creditors from a local remote site, preferably a retail establishment, by interacting with a service provider to inform the creditor of the customer payments at the remote site and enable the creditor to update corresponding customer accounts.

Having described preferred embodiments of a new and improved method and apparatus for facilitating customer payments to creditors from a remote site, it is believed that other modifications, variations, and changes will be suggested to those skilled in the art in view of the teachings set forth herein. It is therefore to be understood that all such variations, modifications, and changes are believed to fall within the scope of the present disclosure as defined in the appended claims.

What is claimed is:

1. An electronic payment transaction system for enabling customers to pay a plurality of creditors via at least one manual payment to an intermediate trustee at a trustee site, comprising:
a trustee processor disposed at the trustee site operable to process the at least one manual payment and to communicate with at least one of a host processor and a kiosk;
the kiosk being disposed proximate to the trustee processor to receive batch payment information, from a customer, pertaining to payments to a plurality of creditors, wherein the kiosk communicates with the host processor, and to process the batch payment information pertaining to the payments to the plurality of creditors; and
the host processor disposed at a service provider site remote from the trustee site and adapted to communicate with the kiosk,
wherein the host processor receives the batch payment information from the kiosk.

2. The payment transaction system of claim 1, wherein said kiosk further includes a storage to store records corresponding to the at least one manual payment in at least one process transaction file for each of the customers.

3. The payment transaction system of claim 1, wherein said trustee processor further includes a storage to store records corresponding to the at least one manual payment in at least one payment disbursement file for each of the customers.

4. The payment transaction system of claim 1, wherein the kiosk communicates with a creditor site for each of the plurality of creditors and transmits the batch payment information therebetween.

5. The payment transaction system of claim 1, wherein the kiosk further includes a receipt generator to selectively generate at least one printed receipt in response to the payments to the plurality of creditors.

6. The payment transaction system of claim 1, wherein the trustee processor further includes a record generator to generate at least one portable record corresponding to the at least one manual payment.

7. The payment transaction system of claim 1, wherein the host processor is further adapted to communicate with at least one creditor site and transmit a subset of the batch payment information therebetween.

8. An electronic payment transaction system for enabling customers to pay a plurality of creditors via a plurality of manual payments to an intermediate trustee at a trustee site, comprising:
a trustee processor disposed at the trustee site to generate and store at least one record of the plurality of manual payments;
a kiosk disposed proximate to the trustee processor to receive batch payment information from a customer pertaining to payments to the plurality of creditors, the kiosk communicating with at least one of the trustee processor and a host processor, and to process the batch payment information pertaining to the payments to the plurality of creditors using the at least one record of the plurality of manual payments; and
the host processor, disposed at a service provider site remote from the trustee site, that communicates with both the trustee processor and the kiosk,
wherein the host processor receives the batch payment information from at least one of the trustee processor and the kiosk.

9. The payment transaction system of claim 8,
wherein the trustee processor further includes a trustee communication device that transmits the batch payment information to the host processor; and
the host processor further comprises a receiver that receives the batch payment information from the trustee processor.

10. The payment transaction system of claim 8,
wherein the trustee processor further includes a portable record generator, and
wherein the at least one record of the plurality manual payments is stored on at least one portable element generated by the portable record generator.

11. A method of enabling a customer of a plurality of creditors to visit a trustee site and manually tender at least one manual payment in response to receiving a creditor statement from each of the plurality of creditors, wherein each of the plurality of creditors is associated with a respective creditor site and the at least one manual payment is tendered at the trustee site and applied to a customer account balance owed to each of the plurality of creditors, the method comprising:
receiving the at least one manual payment at the trustee site from a customer visiting the trustee site and manually tendering the at least one manual payment;
processing, via a trustee processing system disposed at the trustee site, the at least one manual payment and storing at least one record of the at least one manual payment to provide a credited amount;
receiving, via a kiosk disposed proximate to the trustee system, customer account information including the customer account balance owed to each of the plurality of creditors and processing a plurality of creditor payments in which at least a portion of the credited amount is applied to the customer account balance owed to each of the plurality of creditors; and
transmitting the customer payment information to a service provider site,
wherein the customer payment information includes an amount credited to the customer account balance owed to each of the plurality of creditors, and
wherein the service provider site is located at a site remote from the trustee site.

12. The method of payment of claim 11,
wherein processing further comprises generating at least one portable record via the trustee processing system, the at least one portable record indicating at least one of the credited amount and the amount credited to the customer account balance owed to each of the plurality of creditors, and
wherein receiving further includes accessing the at least one portable record and applying the portion of the credited amount to at least a portion of the customer account balance owed to each of the plurality of creditors.

13. The payment processing method of claim 11, further comprising:
transmitting the plurality of creditor payments from the service provider site to the respective creditor site.

14. The electronic payment transaction system of claim 11,
wherein the trustee processing system provides at least one portable record to the customer.

15. The electronic payment transaction system of claim 14,
wherein the customer provides the at least one portable record to the kiosk to complete processing of the plurality of creditor payments.

16. The electronic transaction payment transaction system of claim 11,
wherein the trustee processing system is provided in a first housing and the kiosk is provided in a second housing, and
wherein the first housing and the second housing are physically separated from each other.

17. The electronic payment transaction system of claim 16,
wherein the trustee processing system and the kiosk are collocated, and
wherein the first housing and the second housing are collocated.

18. The electronic payment transaction system of claim 1,
wherein the trustee processor further includes a record generator to generate a single portable record corresponding to a plurality of manual payments,
wherein the single portable record is one of: a bar code, a PIN number, and a machine-readable card.

19. The electronic payment transaction system of claim 8,
wherein the at least one record of the plurality manual payments is stored on a single portable element generated by a portable record generator included in the trustee processor, and
wherein the single portable record is one of: a bar code, a PIN number, and a machine-readable card.

20. The method of claim 11,
wherein the customer provides a single portable record to the kiosk to complete processing of the plurality of creditor payments, and
wherein the single portable record is one of: a bar code, a PIN number, and a machine-readable card.
